(19) United States
(12) Patent Application Publication
(10) Pub. No.: US 2006/0267412 A1
(43) Pub. Date: Nov. 30, 2006

(54) CHIP WITH EMBEDDED ELECTROMAGNETIC COMPATIBILITY CAPACITORS AND RELATED METHOD

(76) Inventor: Hung-Yi Kuo, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/160,659

(22) Filed: Jul. 5, 2005

(30) Foreign Application Priority Data
May 23, 2005 (TW) 094116705

(51) Int. Cl. H04B 3/00

(52) U.S. Cl. 307/89

(57) ABSTRACT

Chips with embedded capacitors for electromagnetic compatibility and related method are disclosed. In a chip, sudden electronic changes occur between power circuits for transmitting power of direct current biasing, and lead to electromagnetic interference of high frequency. In the present invention, capacitors for electromagnetic compatibility are directly embedded in the chip, that is, directly embedding build-in capacitors between power circuits of the chip. In this way, sudden electronic changes between power circuits can be effectively absorbed by the embedded capacitors, and electromagnetic interference is then reduced to provide better electromagnetic compatibility and protection.

### BACKGROUND OF INVENTION

1. Field of the Invention

The invention relates to a chip with embedded electromagnetic compatibility capacitors and related method thereof, and more particularly, to a chip with embedded electromagnetic compatibility capacitors placed between biasing power circuits and related method thereof.

2. Description of the Prior Art

As the manufacturing technique in the processing of the semiconductor has progressed, each electronic system (for example, the computer system) has become one of the most important basic hardware in today's information society. Generally speaking, in the electronic system, one or more chips are built-in. The whole function of the electronic system is implemented by integrating all of the functions of each chip. In order to raise the efficiency of the electronic system, the chip works in a high frequency such that the chip can process more information, manage more data, and transfer more data or signals in a certain time period. However, high efficiency and large data management and transmission implies that the electronic signal changes much more frequently. For example, in a digital circuit, if an electronic signal has to carry more digital data in a certain period of time, the electronic level (e.g., currents or voltages) of the electronic signal has to change more frequently. Moreover, when the chip has to process and transfer the frequently-changed electronic signal, a high frequency electronic interference and electromagnetic interference often will occur as a result. These interferences not only wield influence over the normal operation of the chip, but also because of the noise, radiated outside of the chip, other electronic system or even the user themselves are influenced. Therefore, when the chip works in a high frequency (i.e., at a high clock rate), the method of reducing the electromagnetic interferences generated by the chip becomes important information to the chip providers.

As known by those skilled in the art, modern chips often comprise thousands (sometimes even billions) of circuit units. Circuit units include: transistors, amplifiers, logic gates, or flip-flops of the digital circuit. Each of these circuit units has to be electrically connected to a bias to utilize the power (e.g., the currents), provided by the bias, to change the electronic level of the electronic signal. This causes the electronic signal to be capable of carrying information and data. In other words, different electronic levels represent different information and data. For example, in the digital circuit, each circuit unit (for example, a logic gate or a flip-flop) that is located inside the chip is biased by a positive bias. In this example, the positive bias is a positive voltage Vcc and a ground bias is a ground voltage Vss. When a certain circuit unit A inside the chip has to transfer an electronic signal to another circuit unit B, the circuit unit A regards the circuit unit B as a loading (e.g., a capacitor-type loading). That is, the circuit unit A gets the power, provided by the positive bias, to inject the power into the circuit unit B in order to establish a high electronic level. This means a digital signal “1” is outputted to the circuit unit B from the circuit unit A. On the contrary, if the circuit unit A utilizes the power provided by the ground bias to pull down the electronic level of the circuit unit B it is in this way that a reduction in the electronic level of the circuit unit B can be achieved to cause the electronic level to be brought down to a certain level. This means a digital signal “0” is outputted to the circuit unit B from the circuit unit A.

Because the chip comprises many circuit units, and each circuit unit obtain the power from each bias at the same time, the bias has a very large power supplying loading. Furthermore, in a high-speed chip, each circuit unit changes to obtain the power from different biases in order to transfer and process the high frequency signal. Therefore, the power supplying loading of the biases changes more violently and frequently. This causes a sudden electronic change (e.g., a power bounce or a ground bounce) causing unstable biasing voltages and currents such that the electronic interference occurs.

The electronic interference not only influences the normal operation of each circuit unit to form the noise of the electronic signals, but also is coupled to the outside signal wire. As a result, the electronic interference is transferred to other chips. In addition, the electronic interference may become a high frequency electromagnetic radiation such that an electromagnetic interference is formed.

In order to reduce the above-mentioned electronic and electromagnetic interference, the prior art adds a capacitor outside the chip in order to absorb the electronic interference such that the electromagnetic interference is also reduced. As known by those skilled in the art, each chip in the electronic system is integrated and installed on a circuit board (such as a printable circuit board or a motherboard) such that each chip can be connected to each bias through the power circuits of the circuit boards.

For example, a certain chip is electrically connected to a positive bias and a ground bias through two power circuits. The prior art adds electromagnetic compatibility capacitors between the two power circuits outside the chip. Therefore, when the sudden electronic change occurs, the electromagnetic compatibility is able to utilize the charges stored in the capacitors to compensate for the sudden electronic change. This can relax the sudden electronic change and reduce any related electronic and electromagnetic interferences.

Furthermore, in order to compensate for the high-frequency sudden electronic change, the electromagnetic compatibility capacitor should have good high-frequency characteristics. This means that the electromagnetic compatibility capacitor should have a good high-frequency response such that the capacitor is able to quickly respond, compensate, and filter out the sudden electronic changes.

Nevertheless, the prior art has its disadvantages. The external electromagnetic compatibility capacitor reduces the electronic interferences through the power circuits of the circuit board. Unfortunately, the equivalent resistor and inductor of the power circuits will combine with the electromagnetic compatibility capacitor. This combining will influence the whole high-frequency characteristic of the electromagnetic protection mechanism. As a result, the high-frequency response is slowed down such that the whole electromagnetic protection mechanism cannot compensate for the sudden electronic change in an efficient manor. In addition, the external electromagnetic compatibility capacitor is installed on the circuit board through the utilization of a processing and soldering operation. This increases the production cost and production time of the electronic system. Moreover, the quality of the connecting and soldering points influence the reliability of the whole electronic system.

### SUMMARY OF INVENTION

It is therefore one of primary objectives of the claimed invention to provide a technique for adding an embedded electromagnetic compatibility capacitor inside the chip, to solve the above-mentioned problem of the external capacitor.

In order to transfer the power provided by the biases, the chip comprises a layout of power circuits. The claimed invention sets embedded electromagnetic compatibility capacitors between the power circuits of the chip. Therefore, the embedded electromagnetic compatibility capacitors can directly compensate and slow down the sudden electronic change inside the chip, and further reduce the electronic interference and the electromagnetic interference. Because the claimed invention disposes the electromagnetic compatibility capacitors inside the chip, the above-mentioned equivalent resistor and conductor combination can be enormously reduced. Therefore, the high-frequency characteristic and response of the embedded electromagnetic compatibility capacitors is not influenced such that it can reduce the electronic and electromagnetic interference efficiently. On the other hand, the claimed invention can avoid higher production time and costs that are associated with the external capacitor. The result is an increase in the reliability of the electronic system.

In a preferred embodiment of the claimed invention, a frequency range (i.e., spectrum) of the sudden electronic change and electromagnetic interference can be evaluated and simulated when the chip is being designed. Therefore, the capacitance value of each embedded electromagnetic compatibility capacitor can be evaluated. And then, an embedded electromagnetic compatibility capacitor can be implemented in the circuit layout of the chip. For example, the claimed invention can first place a plurality of capacitors having a predetermined capacitance value between two power circuits in the chip. After the desired capacitance value is evaluated, a few of the capacitors can be selected to establish an equivalent capacitor having the evaluated capacitance value. Therefore, after the selected capacitors are connected between the two power circuits, the embedded electromagnetic compatibility capacitors can be implemented. Please note that the unselected capacitors can be floating, that is, the unselected capacitors are not connected between the two power circuits.

Furthermore, the claimed invention can utilize MOSFETs having different areas to implement capacitors having different capacitance values. The gate of each MOSFET becomes one end of the capacitor, and the source and the drain of each MOSFET becomes another end of the capacitor. Given the present chip manufacturing technology, capacitors can be made to have about 10-1000 PF such that the capacitors can appropriately reduce the electronic and electromagnetic interferences.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of the implementation of an external electromagnetic compatibility capacitors in an electronic system.

FIG. 2 is an electronic system implemented with embedded electromagnetic compatibility capacitors according to the present invention.

FIG. 3 shows multiple embodiments of implementing the embedded electromagnetic compatibility capacitors according to the present invention.

### DETAILED DESCRIPTION

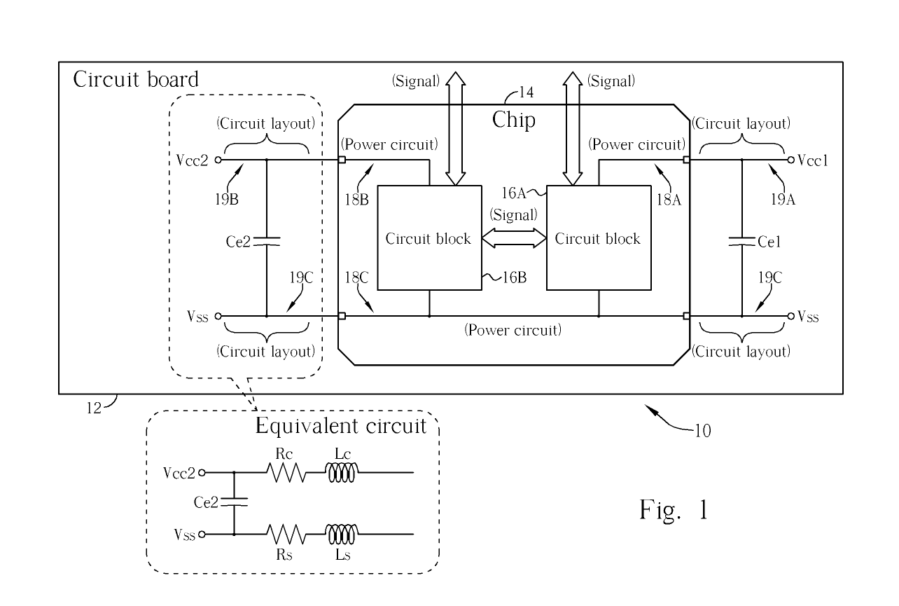

Please refer to FIG. 1, which is a diagram of the implementation of a external electromagnetic compatibility capacitors in an electronic system 10. As shown in FIG. 1, the electronic system 10 can comprise one or more chips. In addition, each chip of the electronic system can be installed on a circuit board 12 such that each chip can exchange signals and data through the circuit layout of the circuit board, and is electrically connected to each DC bias. For a simplified illustration, only a single chip 14 is shown.

As mentioned previously, each circuit of the chip has to be appropriately biased to function. In the case shown, in FIG. 1, the chip 14 comprises two circuit blocks 16A and 16B, which are respectively biased by different DC biases. As shown in FIG. 1, the circuit block 16A is biased by the DC biases Vcc1 and Vss (this can be regarded as a ground voltage), and the circuit block 16B is biased by the DC biases Vcc2 and Vss. The two circuit blocks 16A and 16B can respectively comprise many circuit units (e.g., such as logic gates). Therefore, all circuit units of each circuit block 16A and 16B can obtain electronic power from the DC biases to exchange signals. This can integrate the circuit blocks 16A and 16B to make them work together, and further allows the chip 114 to perform the predetermined functions, such as: signal processing, data transmission management, or data processing.

In order to make the circuit blocks 16A and 16B obtain the power (i.e., currents) from each corresponding bias, the chip 14 comprises the power wire 18A, 18B, and 18C, which are connected to input and output (1/O) ports (e.g., such as 1/O pads, 1/O pins, or balls) of the chip 14. These 1/O ports are connected to power circuits 19A, 19B, and 19C of the circuit board 12. Therefore, the circuit blocks 16A and 16B can be connected to the external DC biases Vcc1, Vcc2, and Vss through the power wires 18A, 18B, and 18C and power circuits 19A, 19B, and 19C.

As mentioned previously, when the chip operates at a high frequency, because the power loading of the bias changes violently, the sudden electronic change occurs such that electronic and electromagnetic interference are generated. In order to reduce the sudden electronic change, a typical technique is employed that involves adding external electromagnetic compatibility capacitors between the power circuits of the circuit board. For example, in FIG. 1, the power circuits 19A and 19C comprise a capacitor Ce1 disposed between them to serve as the electromagnetic compatibility capacitor, and the power circuits 19B and 19C comprise a capacitor Ce2 disposed between them to serve as the electromagnetic compatibility capacitor. When each power circuit encounters a high-frequency sudden electronic change, these capacitors Ce1, Ce2 should be able to utilize their stored charges to compensate for the sudden electronic change in order to reduce the sudden electronic change. Equally, the electromagnetic compatibility capacitor should have a small equivalent impedance in the high-frequency band such that the sudden electronic change passes through these capacitors firstly. For example, when the power circuit 18A encounters a sudden electronic change such that a high-frequency, violent current, or voltage change is generated, then the capacitor Ce1 should utilize its inner charges to compensate for it. Equally, the frequently changed current tends to flow directly from the capacitor Ce1 to the bias Vss in order to reduce the interference of the circuit block 16A.

However, the typical technique shown in FIG. 1 also has disadvantages. Because the electromagnetic compatibility capacitor is externally connected to the outside of the chip, the interferences generated inside the chip have to be absorbed by the electromagnetic compatibility capacitor outside the chip. Therefore, the equivalent conductor and resistor of the power circuit increase the high-frequency impedance of the electromagnetic compatibility capacitor such that the response speed is reduced. This means that the electromagnetic compatibility capacitor cannot efficiently respond to the fast and violent electronic change. In the case of FIG. 1, the equivalent resistor Rc and the conductor Lc of the power circuit 19B and the equivalent resistor Rs and the conductor Ls of the power circuit 19C are serially connected to the capacitor Ce2 such that the capacitor Ce2 cannot perform the electromagnetic protection in an efficient manor. Moreover, the external electromagnetic compatibility capacitor increases production time and adds additional cost. The soldering point between the capacitor and the circuit board also influences the reliability of the whole electronic device.

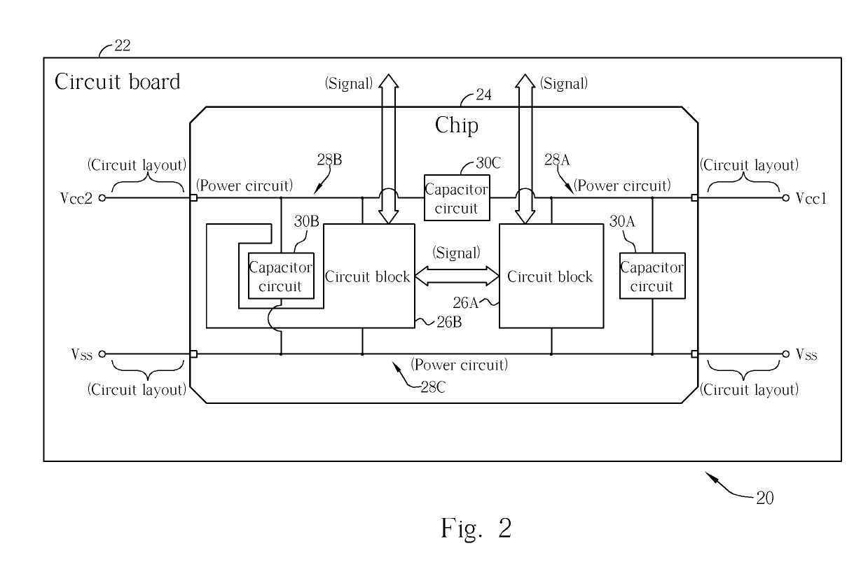

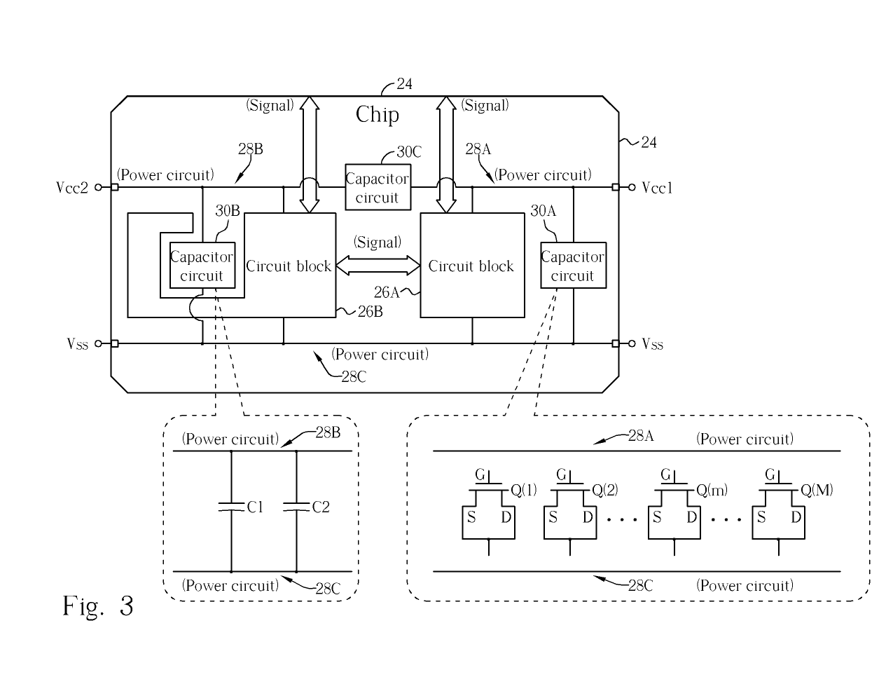

Please refer to FIG. 2 and FIG. 3. FIG. 2 is an electronic system 20 implementing embedded electromagnetic compatibility capacitors according to the present invention. FIG. 3 shows multiple embodiments of implementing embedded electromagnetic compatibility capacitors according to the present invention. First, as shown in FIG. 2m, the electronic system 20 can utilize a circuit board 22 (e.g., such as a printable circuit board or a motherboard) to integrate one or more chips (e.g., such as the chip 24). This makes each chip capable of exchanging data and obtaining power through the signal and power circuit of the circuit board. Furthermore, each chip comprises different circuit block corresponding to different biases. For example, in the chip 24, the circuit blocks 26A and 26B are installed. The circuit block 26A is biased between the DC bias Vcc1 and Vss. The circuit block 26B is biased between the DC biases Vcc2 and Vss. Each circuit block 26A and 26B respectively comprises a plurality of circuit units (such as logic gates, flip-flops, or amplifiers). If all circuit units can appropriately obtain power and operates together, the whole function of the chip 24 can be achieved. For example, the circuit block 26A can be a logic-processing kernel for performing data processing and controlling the whole operations of the chip 24. The bias Vcc1 can correspond to a lower voltage. In addition, the circuit block 26B can be an interface circuit biased by a higher voltage bias Vcc2 in order to obtain stronger power to drive signal transmission and reception of the chip 24.

The chip 24 comprises the power circuits 28A, 28B, and 28C in order to transfer the power of the bias to each circuit block 26A and 26B. These power wires can be a power grid or a power plane implemented by a metal layer of a semiconductor structures. These power circuits 28A, 28B, and 28C are connected to I/O ports (for example, I/O pads, I/O pins, or balls). And the I/O ports are connected to the circuit layouts on the circuit board such that the chip 24 can be coupled to the external biases Vcc1, Vcc2, and Vss through the power circuits 28A, 28B, and 28C and the power circuits.

When implementing the electromagnetic protection mechanism, the present invention can directly install the electromagnetic compatibility capacitors inside each chip of the electronic system. For example, in the chip 24, the present invention places a capacitor circuit 30A between the power wires 28A and 28C to implement the embedded electromagnetic compatibility capacitor. In addition, the capacitor circuit 30B is placed between the power circuits 28B and 28C as the embedded electromagnetic compatibility capacitor. These capacitor circuits 30A, 30B, and 30C can provide capacitor-type impedance. Therefore, when each circuit block 26A and 26B encounters a sudden electronic change in the operation, these capacitor circuits can absorb/compensate the sudden electronic change near the circuit blocks 26A and 26B such that the electronic and electromagnetic interferences of the chip 24 can be reduced. For example, when the power circuit 28A encounters a sudden electronic change, the capacitor circuit 30A (and 30B) can quickly utilize the stored charges to compensate the sudden electronic change. In other words, the high-frequency sudden electronic change is bypassed; the circuit blocks 30A and 30B are no longer influenced such that possible electronic/electromagnetic interferences are reduced.

In contrast, the typical technique shown in FIG. 1, the embedded electromagnetic compatibility capacitor of the present invention shown in FIG. 2 comprises following advantages. First, the embedded electromagnetic compatibility capacitor is installed in the chip in order to prevent the resistor of the external circuit layout from decreasing the efficiency and response speed of the electromagnetic compatibility capacitor. This makes the embedded electromagnetic compatibility capacitor have better high-frequency response such that the embedded electromagnetic compatibility capacitor can quickly compensate the high-frequency sudden electronic change. In fact, as shown in FIG. 2, the present invention capacitor circuit 30B can be embedded inside the circuit block 28B in order to more quickly absorb and compensate for the possible sudden electronic change of the circuit block 28B. Furthermore, embedding the electromagnetic compatibility capacitor inside the chip can reduce the production time and cost of the electronic system and have better reliability.

FIG. 3 shows each embodiment of implementing embedded electromagnetic compatibility capacitors in each capacitor circuit. For example, each capacitor circuit can comprise one or more capacitors. For example, in the case of FIG. 3, the capacitor circuit 30B between the power circuits 28B and 28C can be formed by two capacitors C1 and C2. When the present invention chip is being designed, the operation of the chip can be firstly simulated and analyzed in order to realize which frequency (or frequency band) the sudden electronic change/electronic interference/electromagnetic interference occurs more easily. Therefore, the needed capacitance value of the electromagnetic protection of the frequency (or the frequency band) can be evaluated. Then, the needed capacitance value can be implemented by the capacitor circuits.

Moreover, when the present invention chip is being designed, a plurality of capacitors can be designed to be placed in each capacitor circuit of the chip. In addition, each capacitor can have a predetermined capacitance value. And then, the operation of the chip is simulated and analyzed such that the spectrum of the sudden electronic change and electronic interference or electromagnetic interference can be obtained. Therefore, the frequency band that the electronic change and electronic interference and electromagnetic interference can be known. And then, specific capacitors of the plurality of capacitors inside each capacitor circuit can be selected to compose the needed capacitance value of the electromagnetic protection. Therefore, a layout can be designed such that the selected capacitors can be electrically connected to corresponding power circuits. The other capacitors can be preserved for other uses. Therefore, the chip with embedded electromagnetic compatibility capacitors can be designed and implemented.

In the embodiment shown in FIG. 3, the capacitor circuit 30A utilizes MOSFETs to form the above-mentioned capacitors. In the capacitor circuit 30A, a plurality of MOSFET Q(1) to Q(M) can be placed. In addition, the gate G of each transistor can be one end of the capacitor, and the drain D and the source S (and the base) can be the other end of the capacitor. Therefore, each transistor Q(1) to Q(M) can form the capacitor having a predetermined capacitance value. When the specific transistor (capacitor) is selected according to the needed capacitance value, the specific layout can be designed to connect the gate G of the transistor to the power circuit 28A, and the drain D and the source S are connected to the power circuit 28C. Furthermore, other unselected transistors (capacitors) do not have to be connected to each power circuit. Therefore, the capacitor circuit having a specific capacitance value can be implemented to achieve the function of the electromagnetic protection. In today's chip manufacturing technology, the embedded electromagnetic compatibility capacitor can have about 10-1000 PF capacitance value. Therefore, the electronic and electromagnetic interferences can be appropriately reduced.

To sum up, in contrast to the prior art or the typical external electromagnetic compatibility capacitor positioning, the present invention can directly install the embedded electromagnetic compatibility capacitor inside the chip. Because the operations of the circuits of the chip are the primary reason of the electronic and electromagnetic interferences, if the electromagnetic compatibility capacitor can be directly disposed inside the chip, then the electromagnetic compatibility capacitor can quickly respond to the sudden electronic changes and reduce the electronic and electromagnetic interferences. Because the electromagnetic compatibility capacitor is embedded inside the chip, the present invention can significantly reduce the addition production time and cost associated with the manufacture of the electromagnetic compatibility capacitor, and the reliability of the whole electronic system can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A chip with an embedded electromagnetic compatibility capacitor, the chip comprising:
a plurality of power circuits, wherein each power circuit is utilized to connect a bias outside the chip in order to transfer a power, provided by the bias, between the chip and the bias; and
at least one capacitor circuit, wherein each capacitor circuit is electrically connected between two corresponding power circuits, and each capacitor circuit is capable of providing a capacitor-type impedance between the two corresponding power circuits to absorb a sudden electronic change between the two corresponding power circuits in order to provide a function of electromagnetic protection.

2. The chip of claim 1, wherein each capacitor circuit comprises one or a plurality of capacitors, and two ends of each capacitor are respectively electrically connected to a corresponding power circuit.

3. The chip of claim 2, wherein each capacitor is formed by a corresponding MOSFET, and a gate of the corresponding MOSFET is electrically connected to a corresponding power circuit, and a source and a drain of the corresponding MOSFET are electrically connected to another corresponding power circuit.

4. A method for implementing a chip with an embedded electromagnetic compatibility capacitor, the method comprising:
implementing a plurality of power circuits in the chip, and electrically connect each power circuit to a bias outside the chip in order to transfer a power, provided by the bias, between the chip and the bias; and
implementing at least one capacitor circuit, and electrically connect each capacitor circuit between two corresponding power circuits to make each capacitor circuit capable of providing a capacitor-type impedance between the two corresponding power circuits to absorb a sudden electronic change between the two corresponding power circuits in order to provide a function of electromagnetic protection.

5. The method of claim 4, wherein the step of implementing the capacitor circuit comprising:
implementing a plurality of capacitors on the chip to make each capacitor have a predetermined corresponding capacitance value;
analyzing a possible electromagnetic interference of the chip, and determining an electromagnetic protection capacitance value according to a spectrum of the electromagnetic interference;
selecting at least one capacitor from the plurality of capacitors to make the amount of all capacitance values of the selected capacitor equal to the electromagnetic protection capacitance value; and
electrically connecting the selected capacitor between two corresponding power circuits.

6. The method of claim 5, wherein the step of implementing the plurality of capacitors comprises:
implementing a plurality MOSFETs to utilize each MOSFET as a capacitor.

7. The method of claim 6, wherein the step of utilizing each MOSFET as a capacitor comprises:
utilizing a gate of the MOSFET as one end of the capacitor; and
utilizing a source and a drain of the MOSFET as another end of the capacitor.
